(19) United States
(12) Patent Application Publication
(10) Pub. No.: US 2013/0120209 A1
(43) Pub. Date: May 16, 2013

(54) SYSTEMS AND METHODS PROVIDING PLANAR ANTENNAS INCLUDING REFLECTORS

(71) Applicants: Angus C.K. Mak, Shatin (HK); Corbett R. Rowell, Mongkok (HK)

(72) Inventors: Angus C.K. Mak, Shatin (HK); Corbett R. Rowell, Mongkok (HK)

(73) Assignee: Hong Kong Applied Science and Technology Research Institute Co., Ltd., Shatin (HK)

(21) Appl. No.: 13/296,990

(22) Filed: Nov. 15, 2011

(51) Int. Cl. H01Q 19/30

(52) U.S. Cl. 343/819

(57) ABSTRACT

Systems and methods which utilize a current null cut reflector dipole antenna configuration are shown. According to embodiments, a plurality of current null points are identified with respect to an antenna element reflector configuration whereby a reflector is provided which terminates at the identified current null points. Accordingly, a noncontiguous reflector is provided in current null cut reflector dipole antenna elements. The discontinuity in the noncontiguous reflector is utilized for disposing signal feed paths providing a feed network to the dipole antenna element of the current null cut reflector dipole antenna. Accordingly, current null cut reflector dipole antennas of embodiments may be provided in configurations which are relatively simple and inexpensive to manufacture, such as two-sided printed circuit board configurations.

### TECHNICAL FIELD

The invention relates generally to antennas used for wireless communication and, more particularly, to planar antenna configurations which include reflectors.

### BACKGROUND OF THE INVENTION

The use of devices which implement various forms of wireless communication has become nearly ubiquitous. For example, cellular telephones, wireless personal digital assistants (PDAs), personal computers (e.g., desktop computers, laptop computers, tablet computers, etc.) using wireless local area network (WLAN) and/or cellular data links (CDLs), mobile digital devices (MDDs) using WLAN and/or CDLs, etc. are in wide use today.

With the wide spread use of such wireless devices, issues with capacity and interference in the wireless networks have become pronounced. For example, omni-directional antenna systems providing wireless communication throughout 360° of a service area are prone to providing signal energy in areas outside of that needed to provided the desired communications, potentially causing interference with other wireless devices. Likewise, such omni-directional antenna systems are prone to receiving signal energy from areas outside of that needed to provide the desired communications, resulting in interference from other wireless devices. Such interference issues, as well as other issues such as the relatively low gain provided by omni-directional antennas, can limit the capacity (both in number of wireless devices served and in data throughput) available in the wireless network.

Accordingly, antenna system technology adapted to provide coverage within particular service areas, to avoid interfering with or being interfered by other wireless devices, to facilitate increased capacity, etc. has become important. For example, considerable effort has been expended in the development of antenna systems providing directional antenna beams, such as may be utilized in smart antenna systems. The use of multiple beam, adaptive beam, and/or switched beam smart antenna systems facilitates a higher level of control of signal energy, mitigating many interference issues and facilitating improved communication capacity.

Various antenna element configurations have been utilized in providing directional antenna beams. For example, Yagi aerial configurations, such as shown in U.S. Pat. No. 5,913,549 (the disclosure of which is hereby incorporated herein by reference), have been used to provide highly directional antenna beams. Such Yagi aerials, however, require a significant number of directors when providing a relatively narrow antenna beam and therefore may present an unacceptably large antenna system configuration. Patch antenna configurations, such as shown in U.S. Pat. No. 5,220,335 (the disclosure of which is hereby incorporated herein by reference), have been used in array configurations to provide highly directional antenna beams. Similarly, dipole antenna configurations, such as shown in U.S. Pat. No. 3,742,513 (the disclosure of which is hereby incorporated herein by reference), have been used alone and in array configurations to provide highly directional antenna beams. Such patch and dipole antenna configurations, however, require relatively complex, and potentially costly, feed networks (e.g., require multilayer printed circuit board feed networks, multiport switches, air bridges, etc.).

As a specific example of the aforementioned drawbacks with existing antenna element configurations, attention is directed to FIG. 1A wherein dipole antenna element 100 is shown. Dipole antenna element 100 comprises a 3λ/2 (1.5λ) wavelength dipole antenna bended into λ/2 wavelength stubs. This bended dipole configuration, when fed by a balanced radio frequency (RF) signal, provides directional antenna beams as shown in FIG. 1B. It should be appreciated that the antenna beams provided by dipole antenna element 100 include both front or main antenna beam 101 and rear or back lobe antenna beam 102 of substantially equal size (equal gain). The presence of such a back lobe can result in significant interference associated with the use of dipole antenna element 100.

The use of reflectors and directors has been proposed for use with dipole antenna elements, such as dipole antenna element 110 of FIG. 1A, for controlling undesired lobes, such as back lobe 102. For example, reflector 220 and director 230 may be provided in association with dipole antenna element 110 as shown in FIG. 2A to provide main antenna beam 201 substantially without a back lobe as shown in FIG. 2B. Although providing improvements to the resulting directional antenna beam, the directive beam dipole antenna element configuration of FIG. 2A is not without disadvantage. In particular, feed network 240 is relatively complex, and thus potentially costly, to implement. For example, in addition to balun 241 for providing balanced signal feed, signal feed paths 242 and 243 must be configured to cross over reflector 220, as shown at area 244 of FIG. 2A. Such feed network crossovers require the use of multilayer (e.g., 4 layer) printed circuit boards, air bridges, etc. to isolate the signal feed paths from the reflector. Such feed networks add manufacturing complexity and costs to the antenna system.

### BRIEF SUMMARY OF THE INVENTION

The present invention is directed to systems and methods which utilize a current null cut reflector dipole antenna configuration. According to embodiments of the invention, a plurality of current null points are identified with respect to an antenna element reflector configuration whereby a reflector is provided which terminates at the identified current null points. Accordingly, a noncontiguous reflector is provided in current null cut reflector dipole antenna elements of the present invention. The discontinuity in the noncontiguous reflector is utilized for disposing signal feed paths providing a feed network to the dipole antenna element of the current null cut reflector dipole antenna. Accordingly, current null cut reflector dipole antennas of embodiments may be provided in configurations which are relatively simple and inexpensive to manufacture, such as two-sided printed circuit board configurations. In addition, current null cut reflector dipole antennas of embodiments can eliminate undesired coupling between the feeding network and the reflector.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1A shows a bended dipole antenna element configuration of the prior art;

FIG. 1B shows the radiation pattern provided by the bended dipole antenna element of FIG. 1A;

FIG. 2A shows a bended dipole antenna element configuration of the prior art using a reflector and director;

FIG. 2B shows the radiation pattern provided by the bended dipole antenna element of FIG. 2A;

FIG. 3A shows a current null cut reflector dipole antenna according to embodiments of the invention;

FIG. 3B shows current nulls for identifying the noncontiguous reflector portions of the current null cut reflector dipole antenna of FIG. 3A;

FIGS. 4A-4C show embodiments of feed networks as may be used with respect to the current null cut reflector dipole antenna of FIG. 3A;

FIGS. 5A and 5B show a two-sided printed circuit board implementation of the current null cut reflector dipole antenna of FIG. 3A according to an embodiment;

FIGS. 6A and 6B show radiation patterns for the two-sided printed circuit board implementation of FIGS. 5A and 5B;

FIGS. 7A and 7B show a two-sided printed circuit board implementation of the current null cut reflector dipole antenna of FIG. 3A according to an alternative embodiment;

FIG. 8 shows radiation patterns for the two-sided printed circuit board implementation of FIGS. 7A and 7B; and

FIGS. 9, 10A, 10B, 11A, 11B, 12, and 13 show current null cut reflector dipole antennas according to alternative embodiments of the invention.

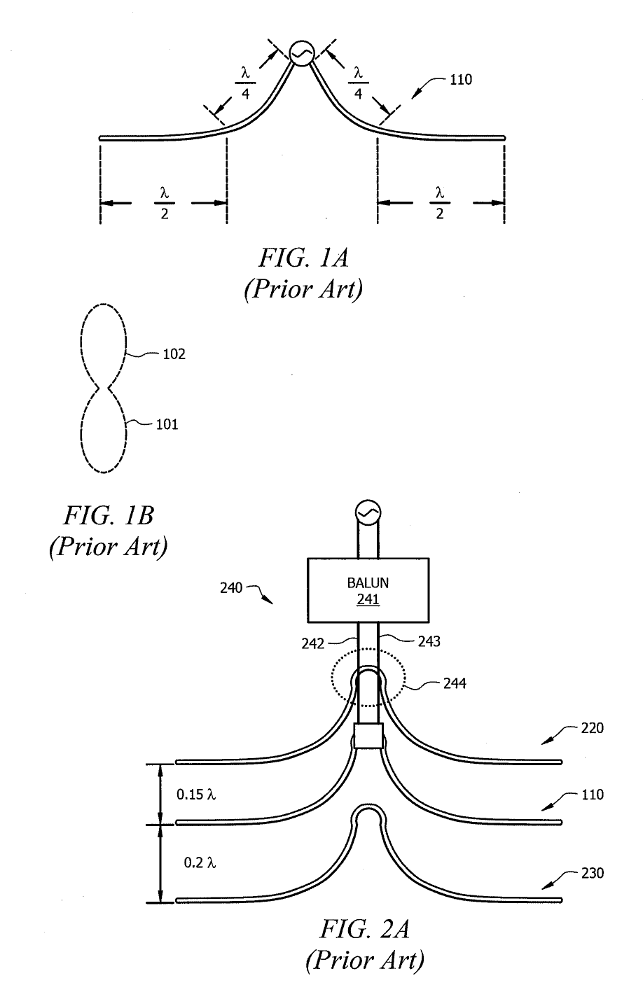

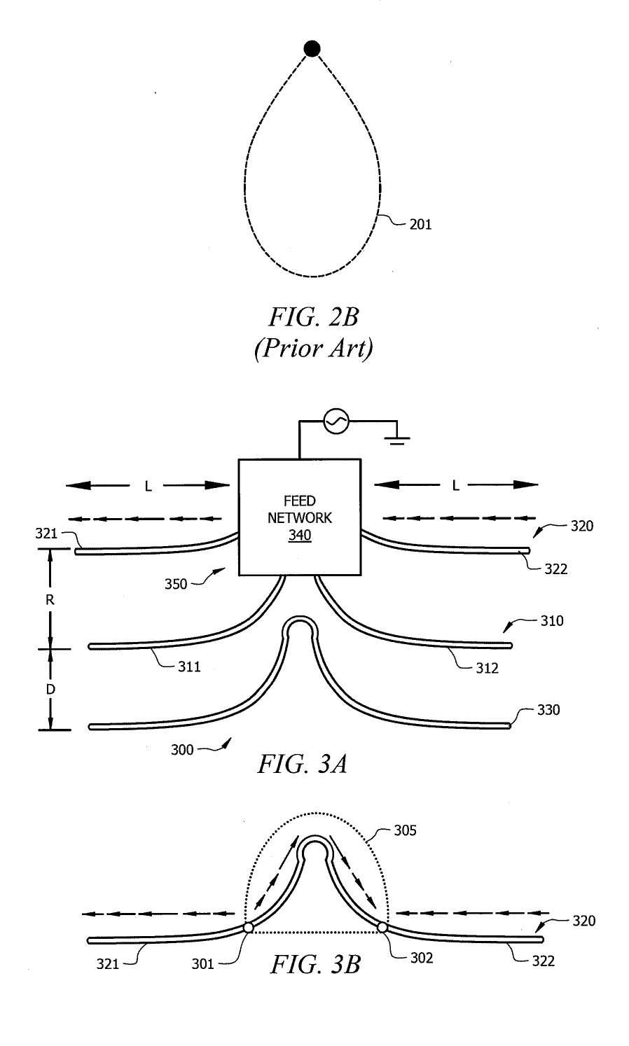

### DETAILED DESCRIPTION OF THE INVENTION

FIG. 3A shows an embodiment of a current null cut reflector dipole antenna according to embodiments of the invention. Specifically, bended current null cut reflector dipole antenna 300 is shown including 1.5 wavelength dipole antenna element 310, current null cut reflector 320, and director 330. Dipole antenna element 310 is coupled to a signal source through feed network 340. Feed network 340 preferably provides a differential (balanced) signal to dipoles 311 and 312 of dipole antenna element 310, and thus may comprise various configurations of a balun and signal feed paths.

The spacing (R) between current null cut reflector 320 and dipole antenna element 310, the spacing (D) between dipole antenna element 310 and director 330, and the length (L) of these components are selected to provide desired operating characteristics (e.g., antenna resonant frequency, antenna beam width, return coefficient, gain, etc.). Such dimensions are preferably related to a wavelength (λ) of signals to be carried by current null cut reflector dipole antenna. For example, according to an embodiment of the invention, wherein dipole antenna element 310 comprises a 1.5λ wavelength dipole antenna configured as λ/2 wavelength stubs, R=0.15λ, D=0.2λ, and L=0.5λ. Of course, other relationships and configurations of components may be utilized according to embodiments of the invention. In typical alternative configurations of a current null cut reflector dipole antenna, both the separation for the reflector and director is usually less than 0.25λ, the length of the reflector is usually longer than the dipole length, and the length of the director is usually shorter than the dipole length.

As can be seen in the embodiment of FIG. 3A, current null cut reflector 320 provides a noncontiguous reflector comprised of reflector portions 321 and 322. It should be appreciated that the placement of discontinuity 350 provided by noncontiguous reflector portions 321 and 322 of current null cut reflector 320 is not arbitrary. According to embodiments of the invention, a plurality of current null points are identified with respect to a base configuration of current null cut reflector 320 for determining placement of discontinuity 350. Portions of the reflector base configuration identified by such current null points may be used as reflector portions 321 and 322 of current null cut reflector 320.

FIG. 3B shows a representation of an uncut configuration of current null cut reflector 320, wherein the arrows represent the direction of current flow. The current null points 301 and 302 are identified in the base bended reflector structure of current null cut reflector 320. Current null points 301 and 302 are points at which the current flow in the reflector structure, when energized in association with operation of associated dipole antenna element 310, is substantially null (e.g., a point at which parasitically induced current reverses direction or is otherwise inconsequential in providing signal reflection). In accordance with the concepts of the present invention, a portion of current null reflector 320 inside of area 305 in FIG. 3B can be omitted (e.g., cut out at current null points 301 and 302) without affecting the performance of the reflector as the current flowing inside area 305 is essentially cancelled.

Referring to FIGS. 3A and 3B, it can be seen that in the illustrated embodiment at least a portion of feed network 340 is disposed in discontinuity 350 provided by the omission of the portion of reflector inside area 305 thus forming reflector portions 321 and 322 of current null cut reflector 320. Discontinuity 350 may be utilized, for example, for disposing signal feed paths of feed network 340 coupling signals to dipole antenna element 310 of current null cut reflector dipole antenna 300. Such embodiments facilitate configurations which are relatively simple and inexpensive to manufacture. For example, as will be better understood from the discussion which follows, embodiments of current null cut reflector dipole antenna 300, including feed network 340, may comprise a two-sided printed circuit board configuration. In addition, undesired coupling at the crossover between feed network 340 and reflector 320 may be eliminated according to embodiments of the invention.

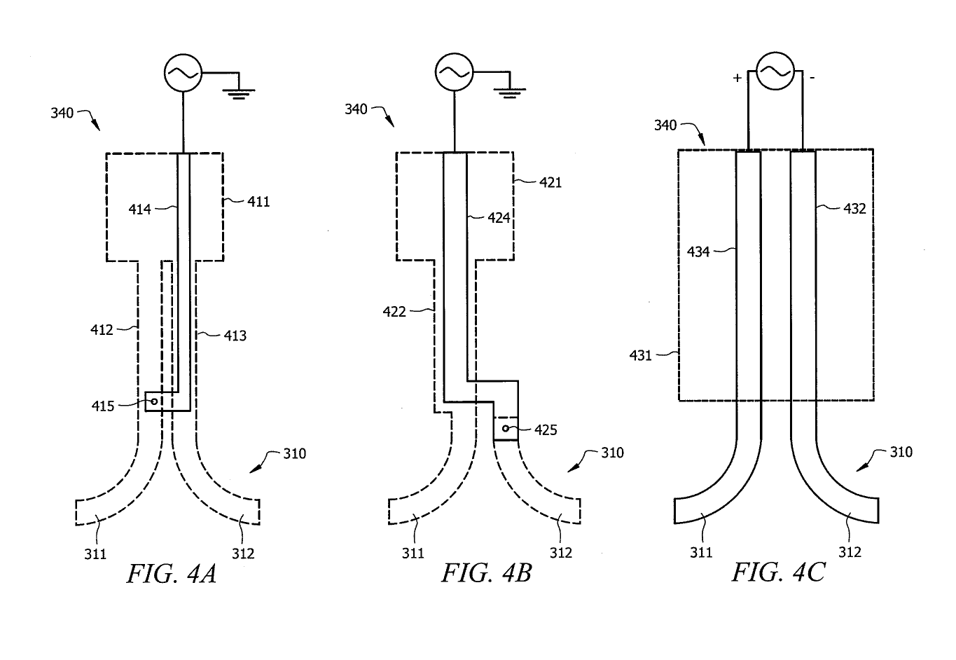

As previously stated, feed network 340 of embodiments provides a differential (balanced) signal to dipoles 311 and 312 of dipole antenna element 310. Various configurations of feed networks may be utilized to provide a differential signal to dipoles 311 and 312. Three examples of feed network configurations as may be utilized according to embodiments of the invention are shown in FIGS. 4A-4C.

FIGS. 4A and 4B show microstrip line balun embodiments of feed network 340. For example, in the embodiment of FIG. 4A ground plane 411, having leads 412 and 413 for coupling to dipoles 311 and 312 of dipole antenna element 310, is disposed upon a first side of a substrate (e.g., printed circuit board). Signal feed path 414 is disposed upon a second side of the substrate, in juxtaposition with lead 413 to thereby provide a microstrip line signal path. Via 415 is provided through the substrate to electrically connect signal feed path 414 and lead 412, thereby providing a differential, balanced signal to dipole antenna element 310 from a single, unbalanced input signal. In the embodiment of FIG. 4B ground plane 421, having lead 422 for coupling to dipole 311 of dipole antenna element 310, is disposed upon a first side of a substrate. Signal feed path 424 is disposed upon a second side of the substrate, in juxtaposition with lead 422 to thereby provide a microstrip line signal path. Via 425 is provided through the substrate to electrically connect signal feed path 424 with a conductive pad upon the first side of the substrate providing connection to dipole 312 of dipole antenna element 310. As with the embodiment of FIG. 4A, the embodiment of FIG. 4B provides a differential, balanced signal to dipole antenna element 310 from a single, unbalanced input signal.

FIG. 4C shows a differential signal feed path embodiment of feed network 340. In the embodiment of FIG. 4C signal feed paths 432 and 434 are disposed upon a first side of a substrate for coupling to a dipole of dipoles 311 and 312 of dipole antenna element 310. Ground plane 431 is disposed upon a second side of a substrate in juxtaposition with signal feed paths 432 and 434 to thereby provide microstrip line signal paths. Unlike the embodiments of FIGS. 4A and 4B, the embodiment of FIG. 4C provides a differential, balanced signal to dipole antenna element 310 from a differential, balanced source.

It should be appreciated that each of the foregoing feed network configurations provides a relatively simple and inexpensive to manufacture configuration. Moreover, due to discontinuity 350 provided by noncontiguous reflector 320 signal feed paths and/or other structure of feed network 340 need not implement air bridges or other techniques for avoiding reflector 320. Accordingly, embodiments of current null cut reflector dipole antenna 300 may be comprised of a two-sided printed circuit board configuration which is relatively simple and inexpensive to manufacture.

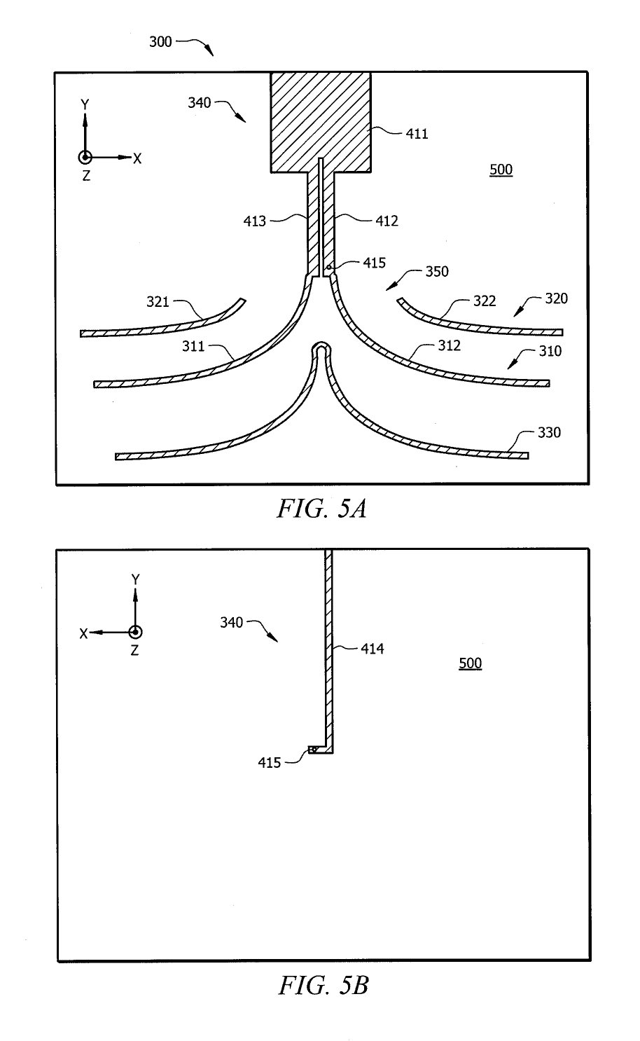

FIGS. 5A and 5B show a two-sided printed circuit board configuration of current null cut reflector dipole antenna 300 according to embodiments herein. As can be seen in FIG. 5A, dipole antenna element 310, current null cut reflector 320, and director 330 (e.g., formed from conductive traces) are disposed upon a first side of substrate 500 (e.g., printed circuit board substrate such as polytetrafluoroethylene, FR-1, FR-2, FR-3, FR-4, CEM-1, CEM-2, CEM-3, CEM-4, CEM-5, etc.). A portion of feed network 340 (ground plane 411, having leads 412 and 413 coupling to dipoles 311 and 312 of dipole antenna element 310) is also disposed on the first side of substrate 500. It should be appreciated that leads 412 and 413, although being in the same plane as reflector portions 321 and 322 of current null cut reflector 320, discontinuity 350 allows isolation of these various components. As can be seen in FIG. 5B, a portion of feed network 340 (signal feed path 414) is disposed upon a second side of substrate 500. Signal feed path 414 is disposed in juxtaposition with lead 413 to thereby provide a microstrip line signal path. Via 415 is provided through substrate 500 to electrically connect signal feed path 414 and lead 412. Accordingly, a relatively simple and inexpensive to manufacture antenna is provided in the two-sided printed circuit embodiment of FIGS. 5A and 5B.

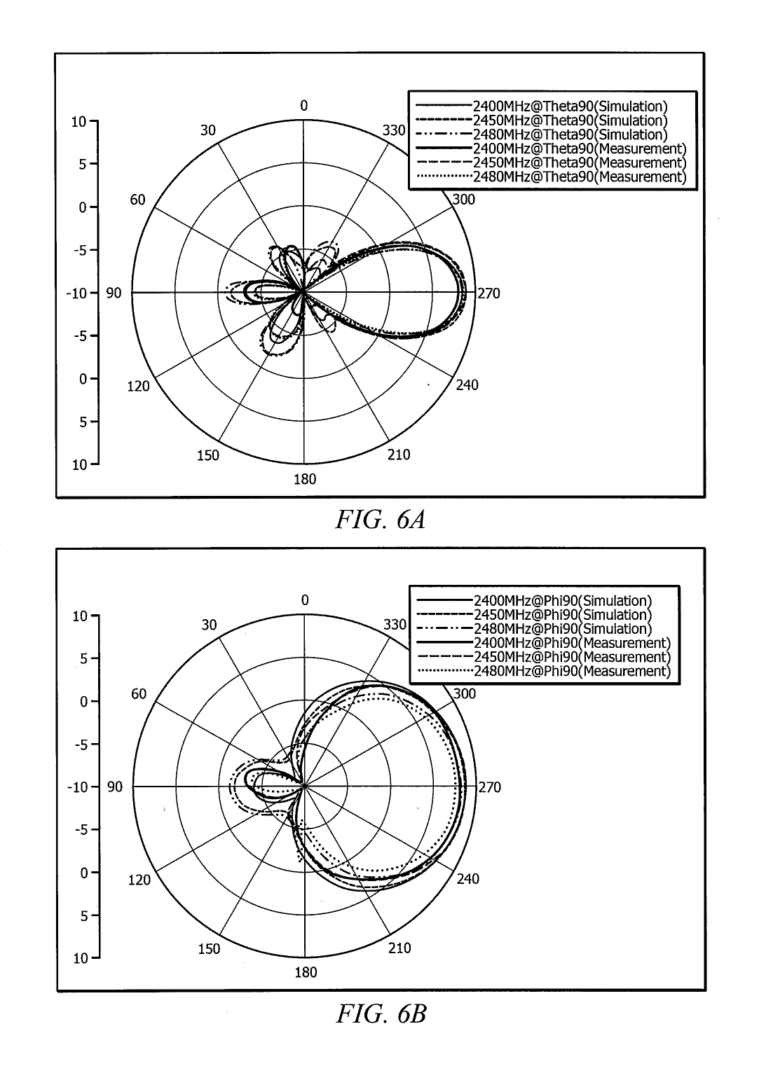

Directing attention to FIGS. 6A and 6B, graphs of the radiation patterns resulting from energizing current null cut reflector dipole antenna 300 of the embodiment of FIGS. 5A and 5B at different frequencies are shown. Specifically, FIG. 6A shows the radiation patterns in the E-plane for signals at 2400 MHz, 2450 MHz, and 2480 MHz. Correspondingly, FIG. 6B shows the radiation patterns in the H-plane for signals at 2400 MHz, 2450 MHz, and 2480 MHz. It can be seen from these graphs that current null cut reflector dipole antenna 300 provides a well defined, relatively narrow main lobe having appreciable gain and relatively small side and back lobes.

It should be appreciated that gain provided by the reflector and director configuration of embodiments of current null cut reflector dipole antenna 300 facilitates a relatively small footprint implementation of the antenna and antenna systems made therewith. Accordingly, in addition to providing advantages in simple, low cost manufacturing, embodiments of the invention facilitate relatively small, high performance antenna systems.

Two-sided printed circuit embodiments of current null cut reflector dipole antennas herein may provide various antenna configurations. For example, a plurality of current null cut reflector dipole antennas may be disposed upon a single printed circuit substrate to provide a multiple beam antenna system.

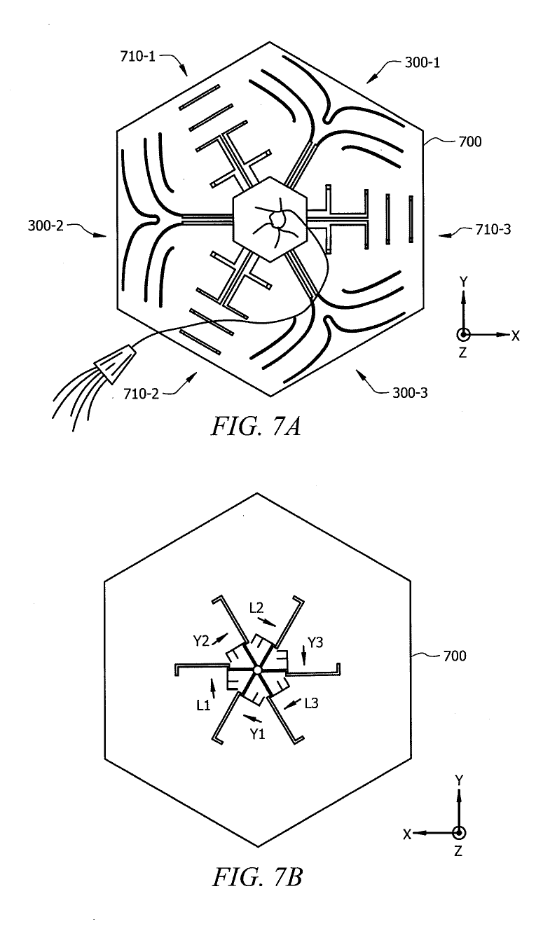

FIGS. 7A and 7B show one embodiment of a two-sided printed circuit board implementation of a multiple beam antenna system comprising a plurality of current null cut reflector dipole antennas. Specifically, FIG. 7A shows a first side of substrate 700 (e.g., printed circuit board substrate) having dipole antenna elements, current null cut reflectors, directors, and portions of feed network of current null cut reflector dipole antennas 300-1 through 300-3 disposed thereon. Correspondingly, FIG. 7B shows a second side of substrate 700 having the other portions of the feed networks of current null cut reflector dipole antennas 300-1 through 300-3 disposed thereon. In the illustrated embodiment, current null cut reflector dipole antennas 300-1 through 300-3 are oriented such that a center of the antenna beam for each is rotated 120° in the azimuth. Such a configuration may be useful in providing sectorized or switched beam communication services.

The size and shape of current null cut reflector dipole antennas 300-1 through 300-3 of the illustrated embodiment provides areas of substrate 700 which may be used for various purposes, such as for additional antenna structures, signal feed paths, feed networks, etc. In the illustrated embodiment, areas of substrate 700 which are not utilized by current null cut reflector dipole antennas 300-1 through 300-3 include additional antenna structures. Specifically, Yagi antennas 710-1 through 710-3 are interleaved with current null cut reflector dipole antennas 300-1 through 300-3 on substrate 700 of the illustrated embodiment.

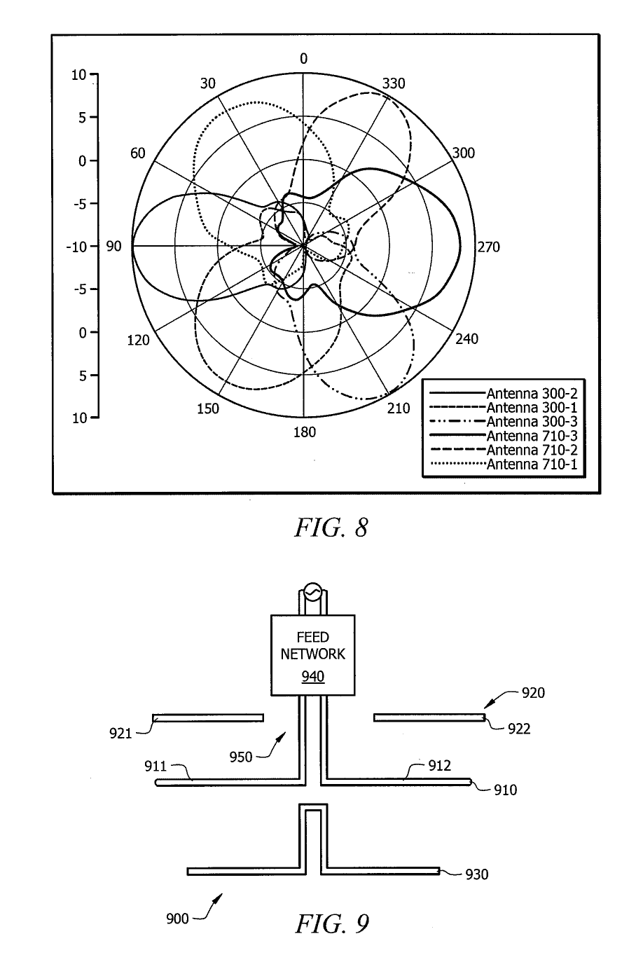

FIG. 8 shows graphs of the radiation patterns resulting from energizing current null cut reflector dipole antennas 300-1 through 300-3 and Yagi antennas 710-1 through 710-3 at a particular frequency (e.g., 2450 MHz). It should be appreciated that Yagi antennas, although being substantially the same size as the current null cut reflector dipole antennas provide a substantially wider antenna beam and provide less gain. Nevertheless, the illustrated embodiment substantially provides for communication coverage throughout a 360° service area.

Although embodiments of current null cut reflector dipole antennas have been described above with respect to a bended dipole configuration, the concepts of the present invention are applicable to other antenna element configurations. FIG. 9 shows an embodiment of a current null cut reflector dipole antenna according to embodiments of the invention. Specifically, non-bended current null cut reflector dipole antenna 900 is shown including dipole antenna element 910, current null cut reflector 920, and director 930. Dipole antenna element 910 is coupled to a signal source through feed network 940. Feed network 940 preferably provides a differential (balanced) signal to dipoles 911 and 912 of dipole antenna element 910, and thus may comprise various configurations of a balun and signal feed paths.

As with current null cut reflector 320 of bended current null cut reflector dipole antenna 300 discussed above, current null cut reflector 920 of non-bended current null cut reflector dipole antenna 900 provides a noncontiguous reflector comprised of reflector portions 921 and 922. The placement of discontinuity 950 provided by noncontiguous reflector portions 921 and 922 of current null cut reflector 920 is preferably associated with a plurality of current null points identified with respect to a base configuration of current null cut reflector 920. Portions of the reflector base configuration identified by such current null points may be used as reflector portions 921 and 922 of current null cut reflector 920.

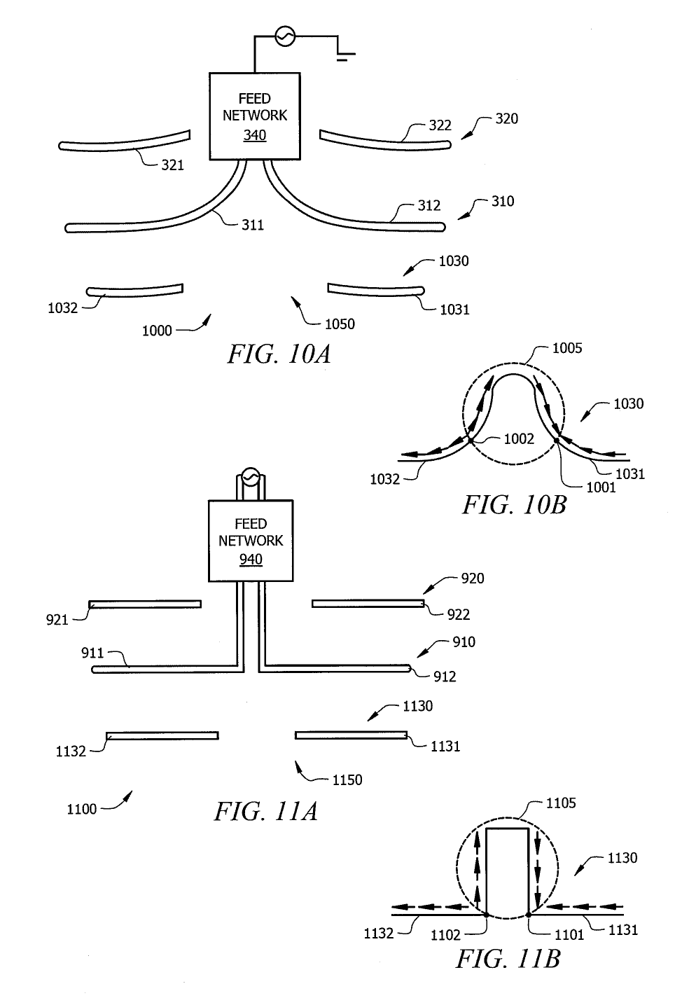

Various other configurations of current null cut reflector dipole antennas may be provided according to embodiments of the invention. FIGS. 10A and 11A, for example, show embodiments wherein a discontinuity is provided with respect to a director of current null cut reflector dipole antennas. Specifically, FIG. 10A shows bended current null cut reflector dipole antenna 1000 configured substantially as bended current null cut reflector dipole antenna 300 discussed above except that the director thereof comprises current null cut director 1030 having discontinuity 1050 provided by noncontiguous director portions 1031 and 1032. FIG. 10B shows a representation of an uncut configuration of current null cut director 1030, wherein the arrows represent the direction of current flow. The current null points 1001 and 1002 are identified in the base bended director structure of current null cut director 1030. Current null points 1001 and 1002 are points at which the current flow in the reflector structure, when energized in association with operation of associated dipole antenna element 1000, is substantially null (e.g., a point at which parasitically induced current reverses direction or is otherwise inconsequential in providing signal reflection). In accordance with the concepts of the present invention, a portion of current null director 1030 inside of area 1005 in FIG. 10B can be omitted (e.g., cut out at current null points 1001 and 1002) without substantially affecting the performance of the director as the current flowing inside area 1005 is essentially cancelled.

FIG. 11A shows non-bended current null cut reflector dipole antenna 1100 configured substantially as non-bended current null cut reflector dipole antenna 900 discussed above except that the director thereof comprises current null cut director 1130 having discontinuity 1150 provided by noncontiguous director portions 1131 and 1132. FIG. 11B shows a representation of an uncut configuration of current null cut director 1130, wherein the arrows represent the direction of current flow. The current null points 1101 and 1102 are identified in the base non-bended director structure of current null cut director 1130. Current null points 1101 and 1102 are points at which the current flow in the reflector structure, when energized in association with operation of associated dipole antenna element 1100, is substantially null (e.g., a point at which parasitically induced current reverses direction or is otherwise inconsequential in providing signal reflection). In accordance with the concepts of the present invention, a portion of current null director 1130 inside of area 1105 in FIG. 11B can be omitted (e.g., cut out at current null points 1101 and 1102) without substantially affecting the performance of the director as the current flowing inside area 1105 is essentially cancelled.

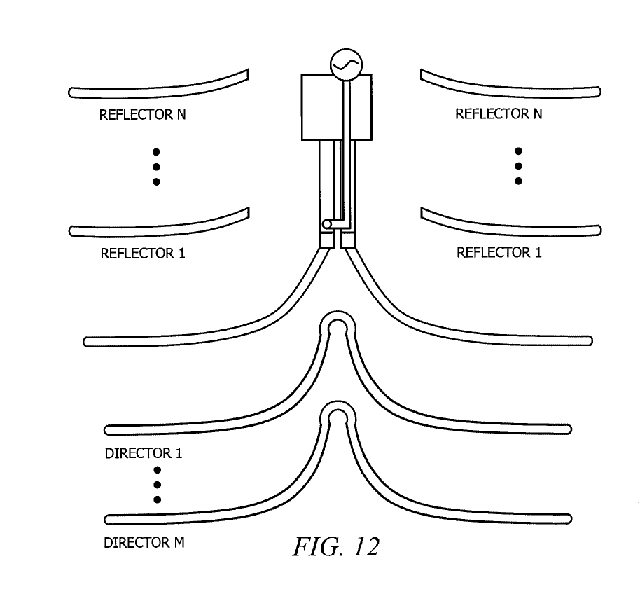

Current null cut reflector dipole antenna configurations of embodiments of the present invention may include a number of reflectors and/or directors other than one as shown in the foregoing embodiments. Accordingly, a null cut reflector dipole antenna of embodiments may comprise N reflectors (N=1, 2, etc.) and M directors (M=1, 2, etc.), where N and M may be the same or different, as shown in FIG. 12. The number of reflectors and directors may be chosen for any particular embodiment based upon the gain and/or beamwidth desired (e.g., the larger the number selected for N and/or M, the higher the gain and the more narrow the beamwidth).

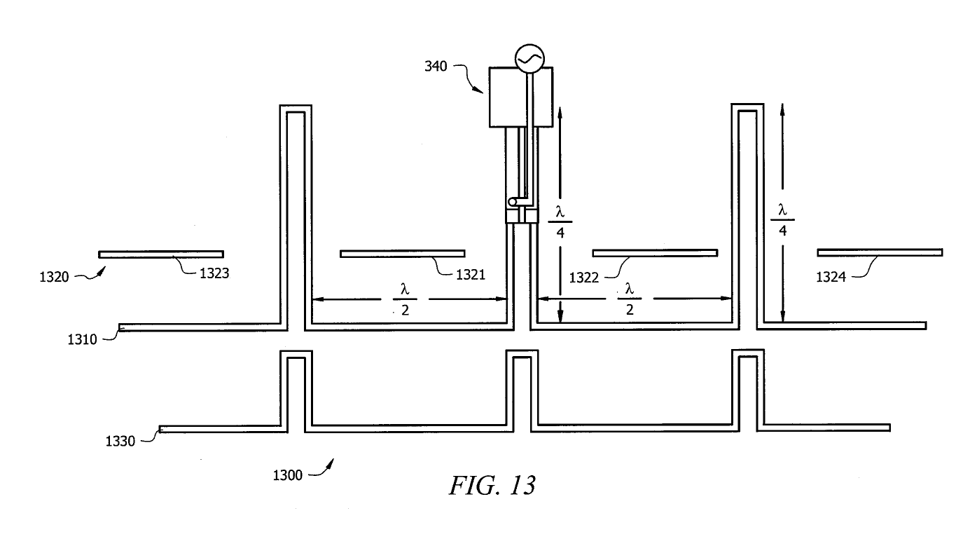

It should be appreciated that current null cut reflector dipole antenna configurations employing a geometry other than the 1.5λ wavelength dipole antenna geometry described above may be provided according to concepts of the present invention. FIG. 13 shows an embodiment employing an 1.5λ+2N (N=0, 1, 2, 3, etc.) wavelength dipole antenna geometry. In the embodiment of FIG. 13, current null cut reflector dipole antenna 1300 includes dipole antenna element 1310 providing an effective length of 3.5 (N=1). Thus, noncontiguous reflector 1320 includes reflector portions 1321-1324 to provide a reflector proportionally sized for the dipole antenna element. Likewise, director 1330 is sized proportionally for the dipole antenna element. Such an embodiment may be utilized where increased gain and/or more narrow beamwidths are desired.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a dipole antenna element; and
a noncontiguous reflector provided in association with the dipole antenna element, the noncontiguous reflector having a plurality of reflector portions separated by a discontinuity.

2. The system of claim 1, wherein the noncontiguous reflector comprises a current null cut reflector.

3. The system of claim 2, wherein an end point of each reflector portion of the plurality of reflector portions is identified by a current null point of a corresponding contiguous reflector configuration.

4. The system of claim 1, wherein the dipole antenna element comprises:
a bended dipole antenna element.

5. The system of claim 4, wherein each reflector portion of the noncontiguous reflector comprises:
at least a partial bend corresponding to that of the bended dipole antenna element.

6. The system of claim 5, wherein the bended dipole antenna element comprises:
a curved dipole antenna element, and wherein the at least a partial bend is a curve corresponding to at least a portion of the dipole antenna element.

7. The system of claim 1, further comprising:
a feed network, wherein at least a portion of the feed network is disposed in a same plane as the noncontiguous reflector within the discontinuity.

8. The system of claim 7, wherein the at least a portion of the feed network disposed within the discontinuity of the noncontiguous reflector comprises:
a lead coupling the feed network to a dipole of the dipole antenna element.

9. The system of claim 7, further comprising:
a two-sided, non-multilayer printed circuit board, wherein the dipole antenna element, the noncontiguous reflector, and the feed network are provided as conductors of the printed circuit board without the use of an air bridge.

10. The system of claim 9, wherein the feed network comprises:
a balun.

11. The system of claim 1, further comprising:
a director provided in association with the dipole antenna element.

12. The system of claim 11, wherein the director comprises:
a current null cut director, wherein the current null cut director is a noncontiguous director having a plurality of director portions separated by a discontinuity.

13. The system of claim 12, wherein an end point of each director portion of the plurality of director portions is identified by a current null point of a corresponding contiguous director configuration.

14. The system of claim 1, wherein the plurality of reflector portions comprises:
more than two reflector portions.

15. The system of claim 14, wherein the more than two reflector portions are disposed in a lateral arrangement to effectively provide a reflector of greater length.

16. The system of claim 14, wherein the more than two reflector portions are disposed in a multiple reflector configuration providing a plurality of reflectors behind the dipole antenna element.

17. A method comprising:
providing a dipole antenna element; and
providing a noncontiguous reflector in association with the dipole antenna element, the noncontiguous reflector having a plurality of reflector portions separated by a discontinuity.

18. The method of claim 17, further comprising:
identifying an end point of each reflector portion of the plurality of reflector portions by a current null point of a corresponding contiguous reflector configuration.

19. The method of claim 17, further comprising:
providing a feed network coupled to the dipole antenna element, wherein at least a portion of the feed network is disposed in a same plane as the noncontiguous reflector within the discontinuity.

20. The method of claim 19, wherein the providing a dipole antenna element, providing a noncontiguous reflector, and providing a feed network comprises:
providing a two-sided, non-multilayer printed circuit board having the dipole antenna element, the noncontiguous reflector, and the feed network disposed thereon as conductors of the printed circuit board without the use of an air bridge.

21. The method of claim 17, further comprising:
providing a director in association with the dipole antenna element.

22. The method of claim 21, wherein the director has a plurality of director portions separated by a discontinuity, the method further comprising:
identifying an end point of each director portion of the plurality of director portions by a current null point of a corresponding contiguous director configuration.

23. The method of claim 17, wherein the providing a noncontiguous reflector comprises:
providing more than two reflector portions, wherein the more than two reflector portions are disposed in a lateral arrangement to effectively provide a reflector of greater length.

24. The method of claim 17, wherein the providing a noncontiguous reflector comprises:
providing a plurality of noncontiguous reflectors in association with the dipole antenna element, wherein each noncontiguous reflector of the plurality of noncontiguous reflectors have a plurality of reflector portions separated by a corresponding discontinuity, wherein the plurality of noncontiguous reflectors are disposed in a multiple reflector configuration providing a plurality of reflectors behind the dipole antenna element.

25. A dipole antenna comprising:
a dipole antenna element;
a current null cut reflector, the current null cut reflector having a plurality of reflector portions an endpoint of each of which is identified by a current null point in a corresponding base reflector configuration, wherein an area of discontinuity is provided between the plurality of reflector portions; and
a feed network coupled to the dipole antenna element, wherein at least a portion of the feed network is disposed in the area of discontinuity.

26. The dipole antenna of claim 25, further comprising:
a two-sided, non-multilayer printed circuit board substrate, wherein the dipole antenna element, the current null cut reflector, and the feed network are disposed as conductors upon the printed circuit board substrate, and wherein a conductor portion of the feed network is disposed on as the plurality of reflector portions and passes between the plurality of reflector portions on that same side of the printed circuit board substrate.

27. The dipole antenna of claim 25, further comprising:
a current null cut director, the current null cut director having a plurality of director portions an endpoint of each of which is identified by a current null point in a corresponding base director configuration, wherein an area of discontinuity is provided between the plurality of director portions.

28. The dipole antenna of claim 25, wherein the plurality of reflector portions comprises:
more than two reflector portions disposed in a lateral arrangement to effectively provide a reflector of greater length than individual ones of the reflector portions.

29. The dipole antenna of claim 25, further comprising:
a second current null cut reflector, the second current null cut reflector having a plurality of reflector portions an endpoint of each of which is identified by a current null point in a corresponding base reflector configuration, wherein an area of discontinuity is provided between the plurality of reflector portions of the second current null cut reflector, and wherein the at least a portion of the feed network is also disposed in the area of discontinuity of the second current null reflector.

30. The system of claim 25, wherein the dipole antenna element comprises a bended dipole antenna element, and wherein each reflector portion of the current null cut reflector comprises at least a partial fold corresponding to that of the bended dipole antenna element.

31. The system of claim 30, wherein the bended dipole antenna element comprises:
a curved dipole antenna element, and wherein the at least a partial fold is a curve corresponding to at least a portion of the dipole antenna element.
